(19) United States
(12) Patent Application Publication
(10) Pub. No.: US 2022/0040576 A1
(43) Pub. Date: Feb. 10, 2022

(54) Systems and Methods for Dynamically Modifying the Scope of Virtual Reality Environments

(71) Applicant: MassVR, LLC, Skokie, IL (US)

(72) Inventor: Roberto Ritger, Skokie, IL (US)

(21) Appl. No.: 17/397,513

(22) Filed: Aug. 9, 2021

Related U.S. Application Data
(60) Provisional application No. 63/062,824, filed on Aug. 7, 2020.

(51) Int. Cl. A63F 13/5375; G06T 19/00; G02B 27/01

(52) U.S. Cl. CPC A63F 13/5375; G02B 27/0172; G06T 19/006

(57) ABSTRACT

Systems and methods for dynamically modifying a scope of a virtual reality environment. The system includes one or more user virtual reality devices associated with one or more users, respectively, a processor, and a memory. The processor is configured to provide the virtual reality environment to the one or more users through the one or more user virtual reality devices, wherein the virtual reality environment includes a main area and at least one restricted area accessible through a virtual offset, wherein the virtual offset is set to a locked position or an unlocked position, when the virtual offset is unlocked, provide the one or more users access to the restricted area through the virtual offset, and when the virtual offset is locked, restrict the one or more users from accessing the restricted area through the virtual offset.

### CROSS-REFERENCE TO PRIOR FILED APPLICATIONS

This application incorporates by reference and claims the benefit of priority to U.S. Provisional Application No. 63/062,824 filed on Aug. 7, 2020.

### BACKGROUND OF THE INVENTION

The present subject matter relates generally to systems and methods for dynamically expanding the scope of virtual reality environments. More specifically, the present invention relates to systems and methods for adapting a virtual environment during a game as the number of active players changes.

Virtual reality (VR) systems are digitally rendered environments in which users immerse themselves in a virtual experience. These environments can be modeled after real or imaginary locations. Current technology allows users to explore these environments using a head-mounted display (HMD), often in conjunction with other equipment such as handheld controllers or movement-tracking clothing. HMDs display a virtual environment in front of the user's eyes. The HMDs can take a variety of forms, such as glasses, goggles, helmets etc. Some systems allow users to explore the virtual world by moving through their physical environment, such movement corresponding to and controlling movement in the virtual world. These real and virtual movements are usually limited in scope and range by the environment in which the user is physically located and by the virtual environment the user is exploring. While a user is immersed in a virtual reality system, the user's HMD typically prevents the user from seeing his or her physical surroundings; this is a tautological requirement of an immersive virtual experience.

Augmented reality (AR) combines the virtual and the real world by overlaying images of virtual objects on the user's display of the physical world. These objects can be viewed through handheld or head-mounted devices; for example, a smartphone app could use the device's camera to display the user's surroundings superimposed with virtual images on the screen. This gives the user awareness of their surroundings while providing extra information through the use of virtual objects. Though AR poses a variety of possibilities, it does not provide the same immersive experience that VR does because it is constrained to working within the constraints of the user's physical location.

One of the great promises of VR systems is that they do not limit user's experiences in the same way the physical environment does. The less restricted a user is by his or her physical environment, the more complete and immersive the VR environment can be. VR environments can be displayed to users as though they are larger than the actual physical environment constraining the users. VR environments can be displayed to users in shapes and configurations that do not match identically to the users' physical environment.

For example, VR environments can be displayed to users such that a user may appear to be changing in elevational space even when not moving vertically in the physical space. A user may take an elevator (or escalator, ramp, zipline, etc.) to a “second level” in the VR environment even when the user's elevational position in the physical space has not changed at all. Similarly, the VR environment may display a change in elevation to a user that is riding in a hot air balloon even when the user's elevational position has not changed at all in the physical space.

The flexibility in expanding the VR environment beyond the limits of the corresponding physical environment creates a more immersive experience for the players. The greater the differences are between the physical space and the virtual environment, players the more the player is able to disconnect from the physical space and connect to the virtual environment. However, it is possible that the virtual environment may be expanded to an overwhelming degree. For example, if a team of players is unable to locate each other within the game, the players begin to question the virtual environment. Ideally the size of the virtual environment is optimized for the number of active users.

A related problem arises when the number of players wishing to participate in a virtual environment is different from the number of players for which the virtual environment was designed. Typically a virtual environment based on a corresponding physical space is sized for a certain number or small range of players, such as eight, or six to ten, players. If a group of four players want to play, they must wait for another two players to arrive. If a group of 14 players want to play, the group must be split into two subgroups of six and eight and take turns playing.

One solution to the problems noted above is to create small, medium, and large virtual environments based on the space, and offer a specific size virtual environment based on the number of players. This solution does not allow for adapting the environment when players want to join or leave mid-game.

Accordingly, there is a need for systems and methods for dynamically modifying a virtual environment to adjust the size of the virtual environment to the number of active players, as described herein.

### BRIEF SUMMARY OF THE INVENTION

To meet the needs described above and others, the present disclosure provides systems and methods for dynamically modifying a virtual environment based on the changing number of participants actively engaging in the game. The systems and methods also allow for dynamically modifying the virtual environment to maintain a pace of the game if the initially selected size is not optimal for the group of players or needs to be expanded or minimized as the number of players changes. The systems and methods are implemented through the design of a virtual environment including areas having restricted access and adjusting access to the restricted areas based on the number of active players.

For purposes of this disclosure, VR systems are understood to be a combination of one or more devices through which a VR environment may be displayed to a user and with which the user may explore and interact. Of particular relevance are multi-user VR environments in which multiple users interact within a single VR environment and, even more relevant, are instances in which multi-user VR environments are provided in which two or more of the users are located within the same physical environment. Additionally, the systems and methods provided herein are particularly relevant to VR environments in which the VR environment is different shaped than the physical environment in which the user interacts with the VR environment (e.g., the VR environment is larger, the VR environment includes a greater number of levels, situations in which the real environment includes obstacles that are absent in the VR environment).

These devices used within the VR system may include, but are not limited to, head-mounted displays (HMDs), wearable computing systems, server or cloud-based computing systems, tracking systems (e.g., laser based, camera based, etc.), motion controllers, handheld controllers, and any other such device that aids in user tracking and virtual immersion, as will be recognized by one having ordinary skill in the art with respect to the subject matter presented herein.

VR environments can be constructed to match, on a one-to-one basis, the physical environment in which the user will be located when interacting with the VR environment (dimensions, elevations, etc.). However, VR environments can get even more interesting when they are unbound by the limitations of the users' physical spaces. When X, Y, and Z offsets are implemented within a VR environment (i.e., the user's position in the VR space is offset from the user's position in the user's physical space in any one or more of the X, Y, or Z axis), the size of the VR environment can be unbound.

In order to optimize the experience for the players, the size of the virtual environment is scaled to the number of users. Expanding the virtual environment beyond the limitations of the physical space allows the player to disconnect from the physical space and become immersed in the virtual environment. However, providing a virtual environment that is too large or too small for a group of players detracts from the immersive experience. When teammates are unable to locate each other within a virtual environment, players become lost or confused, detracting from the virtual experience. When a player cannot sufficiently hide from the opposing team within a virtual environment, players become frustrated, creating a tense virtual experience.

By providing a virtual environment having restricted areas that can be made either available or unavailable during a game, the size of the virtual environment can be adjusted in real-time while the players are engaged in the game. In one embodiment, each of the virtual and physical environments may include a main area of 3,200 square feet. In some embodiments, the addition of players requires a virtual environment increase of 1,000 to 2,000 square feet per person and a physical environment increase of 400 to 800 square feet per person. These values are provided as non-limiting examples and are dependent on other factors related to the physical and virtual environments. A 3,200-square foot VR area may be optimized for a game of eight players, while a 4,400-square foot VR area may be optimal for ten players. These increases are provided through by enabling access to a restricted areas within those ranges. As players join and leave the virtual game, access to the restricted areas may be locked or unlocked as needed.

In an embodiment, access to the restricted areas is provided through a virtual offset that can be made available or unavailable to users within the virtual environment. The virtual offset is a virtual graphic or action in the virtual reality environment that moves between an operable, or unlocked, position and an inoperable, or locked position. In the operable position, a player can interact with the virtual offset in order to move to a different area within the virtual reality.

For example, a warehouse in the main space of the virtual environment may include a trampoline that propels users to an upper level as the first restricted area. At the start of the game, the main space accommodates the six active players, and the trampoline is “broken” and unavailable to users, thereby restricting access to the upper level. Thirty minutes into the game, two new players join and additional virtual reality area is needed to accommodate the new players. The system modifies the virtual reality environment to change the status of the trampoline from “broken” to “operable” such that players are able to access the trampoline and be propelled to the upper level. All eight players therefore have access to the main area and the first restricted area. Other virtual offsets that can be used to prevent or provide access to restricted areas include a manhole or sewer access, zip lines, and elevators.

Further virtual offsets enable the player to adjust their location in the physical space without moving from a physical location. For example, a player may engage with a catapult mechanism in the virtual environment and be launched into the air. In the physical space, the player remains in a single location with his feet planted on the ground. Adjustments made with the body in the physical space allow the player in the virtual environment to control where he lands. While most offsets such as a manhole provides a shift along a single axis (i.e. either of the x-axis or the y-axis), the catapult mechanism provides an offset in both of the x and y directions.

By controlling access to restricted areas while a consistent number of players are engaged in the virtual environment, the pace of the game can also be controlled. An operator of the game selects whether access to one or more restricted areas should be given at the start of the game, and adds or removes access as the number of players changes. The operator may also add or remove access to restricted areas if the space is not optimized for the number of players. For example, a group of six adults may require a greater square footage of the virtual environment than a group of six ten-year-old kids. The operator can also monitor the player's actions in the game and adjust access to restricted areas based on the players' behavior.

A system for dynamically modifying a scope of a virtual reality environment comprises a user virtual reality device associated with a user, a processor in communication with the user virtual reality device and a memory in communication with the processor. The memory stores program instructions that, when executed by the processor, cause the processor to provide the virtual reality environment to the user through the user virtual reality device. The virtual reality environment includes at least one restricted area accessible through a virtual offset, and the virtual offset is set to one of a locked position and an unlocked position. The program instructions further cause the processor to provide the user access to the restricted area through the virtual offset when the virtual offset is unlocked and restrict the user from accessing the restricted area through the virtual offset when the virtual offset is locked.

In a further embodiment, a method of dynamically modifying a scope of a virtual reality environment comprises the steps of providing a user virtual reality device to a user and providing the virtual reality environment to the user through the user virtual reality device. The virtual reality environment includes at least one restricted area accessible through a virtual offset, and the virtual offset is set to a locked position or an unlocked position. The method further comprises the steps of providing the user access to the restricted area through the virtual offset when the virtual offset is unlocked and restricting the user from accessing the restricted area through the virtual offset when the virtual offset is locked.

An object of the invention is to provide a solution to increase or decrease the size of the virtual environment provided to a plurality of players during a game.

Another object of the invention is to pace the game for the active players, adjusting the size of the virtual environment based on user experience.

Another object of the invention is to efficiently utilize a physical environment by designing a single virtual environment having a size that can be modified based on the number of players.

Additional objects, advantages, and novel features of the solutions provided herein will be recognized by those skilled in the art based on the following detail description and claims, as well as the accompanying drawings, and/or may be learned by production or operation of the examples provided herein.

### BRIEF DESCRIPTION OF THE DRAWINGS

The figures depict one or more embodiments of the subject matter described herein. They are provided as examples only. Within the figures, reference numbers are used to refer to elements described in the detailed description.

FIG. 1 is a schematic diagram illustrating examples of components of a system for dynamically modifying a scope of a virtual reality environment.

FIG. 2 is an example of a schematic design VR environment illustrating restricted areas.

### DETAILED DESCRIPTION OF THE INVENTION

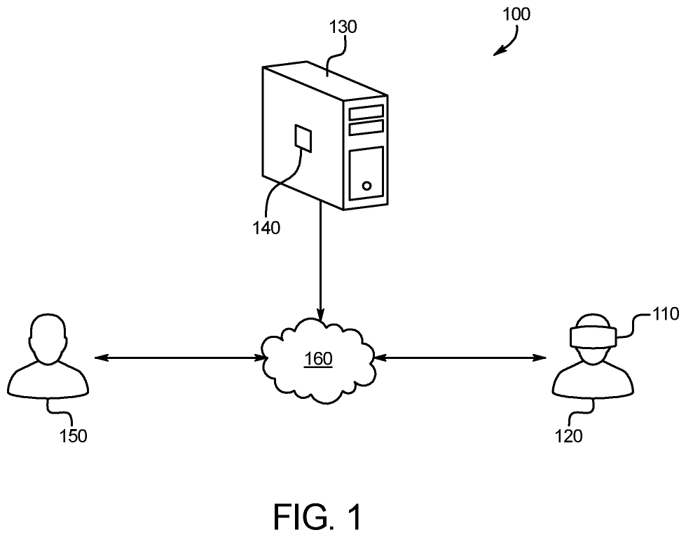

FIG. 1 illustrates a system 100 for dynamically modifying a scope of a virtual reality environment. Specifically, the system 100 is particularly useful in dynamically modifying a virtual environment in order to optimize the area of the virtual environment available to a changing number of players and/or to players whose experience levels warrant changes mid-game. In principle embodiments, the system 100 provides a virtual environment including one or more restricted areas and allows or restricts access to the restricted area through an offset that can be unlocked or locked, respectively, during the game.

In the embodiment illustrated in FIG. 1, the system 100 includes: one or more user virtual reality devices 110 (e.g., an HMD) worn by a participant 120, a processor 130 in communication with the one or more user virtual reality devices 110, and a memory 140 in communication with the processor 130. An operator 150 is available to monitor the system 100. The memory 140 stores program instructions that, when executed by the processor 130, cause the processor 130 to perform the features and functions described herein. The processor 130 provides the virtual relative environment to the user virtual reality devices 110 through a wireless communication system 160. The operation 150 also accesses the processor 130 through the wireless communication system 160.

The processor 130 may present a virtual reality environment that uses at least X, Y, or Z-axis offsets to unbind the scope of the virtual reality environment from an associated physical environment to the user virtual reality devices 110 of all active players. An offset occurs where a player moves along the X, Y, and/or Z axis within the virtual environment while remaining in the same location in the physical space throughout the movement. Through the use of offsets, the virtual environment is unbound from the limits of the physical environment.

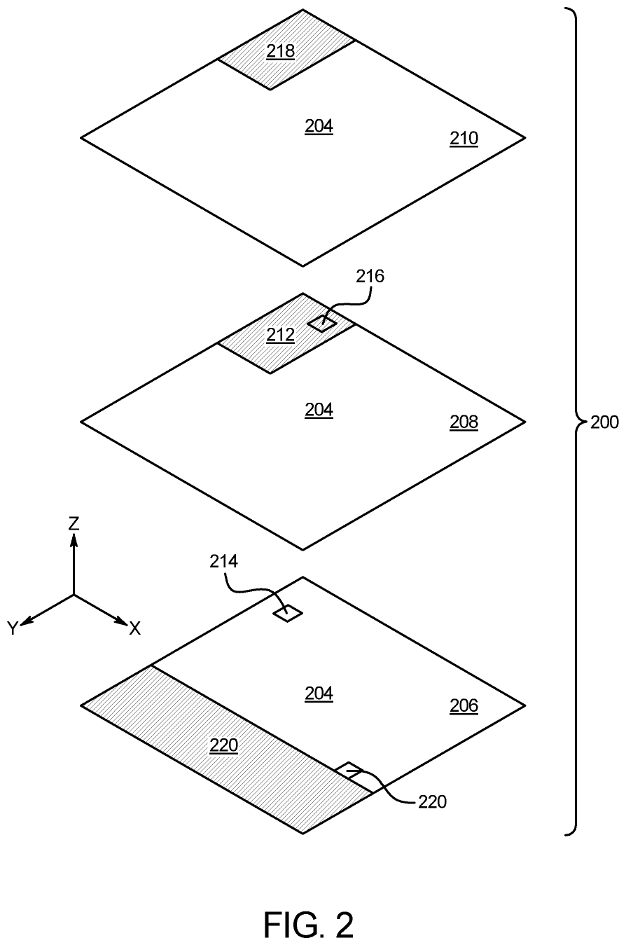

Referring to FIG. 2, offsets are also used to provide or restrict access to certain areas in the virtual environment 200 of the present application. By providing a virtual environment 200 having restricted areas that can be locked and unlocked, the size of the virtual environment can be adjusted in real-time as the players are engaged in the game. During a game, accesses to restricted areas within the virtual environment can be locked or unlocked. Active players in the game can only access the restricted area if the offset providing such access is operational, or unlocked. If the offset is inoperational, or locked, players cannot engage the offset and reach the restricted area.

In one example, a main area in the virtual environment may include a manhole in the ground, which provides an offset along the z-axis. A sewer line running below the main area of the game is accessible through the manhole as a restricted area. If the manhole cover is locked, access to the restricted area is not allowed and a player can only walk atop the manhole cover. If the manhole cover is removed, access to the restricted area is allowed and a player can jump through the manhole cover into the sewer line, exploring a new area of the virtual environment.

FIG. 2 illustrates a virtual environment 200 based on a corresponding physical space 202. The main area 204 includes the majority of a first floor 206, a second floor 208, and a third floor 210. Players can move through the main area 204, having a main area surface area, without restriction. A first restricted area 212 located on the second floor 208 is accessible through a first offset 214 such as an elevator on the first floor 206. If access to the first restricted area 212 is restricted, the elevator 214 is shown as out of service in the virtual environment. If the virtual environment 200 needs to expand during the game, the elevator 214 can become operational in order to provide access to the first restricted area 212. When the elevator 214 is operational, the users 120 can explore the main area 204 and the first restricted area 212, corresponding to the main area surface area and a first restricted area surface area.

Within the first restricted area 212, a second offset 216 is provided to provide access to a second restricted area 218, as needed. The second offset 216 is also along the z-axis, accessible through an offset such as an elevator, a jet pack, or a hot air balloon. Each of these features may be provided as out of service or locked if access is restricted and in service and unlocked if access is allowed. When the second offset 216 is operational, the users 120 can explore the main area 204, the first restricted area 212, and the second stricted area 218, corresponding to the main area surface area, the first restricted area surface area, and a second restricted area surface area.

A third offset 220 on the first floor 206 provides access to a third restricted area 222 as needed. The third offset 220 enables movement along the y-axis and may be a zipline, a skateboard, or other similar feature. Virtual offsets may similarly enable movement along the x-axis as well. As with the offsets noted above, these features may be provided as out of service if access is restricted and in service if access is allowed. When the third offset 220 is operational, the users 120 can explore the main area 204 and the third restricted area 222, corresponding to the main area surface area and a third restricted area surface area, plus any additional restricted areas with virtual offsets in the unlocked position.

Access to restricted areas 212, 218, 222 may be provided or restricted based on the changing number of players in a game. In one example, a game may begin with ten players having access to the main area 204, the first restricted area 212, and the second restricted area 218. Four of the players leave during the game, so the virtual reality environment is adjusted to close access to the second restricted area 218.

Access to restricted areas 212, 218, 222 may also be provided or restricted based on the observed pace of the game. For example, the size of the virtual environment 200 may initially be selected based on the number of players 120 with a 3,200-square foot VR area for a game of eight players. The eight players may be extremely experienced such that a greater VR area may be needed to improve user engagement and enjoyment. The operator 130 of the game may unlock virtual offsets to provide access to one or more of the restricted areas 212, 218, 222 as needed during the game. In other embodiments, the system 100 may monitor user collisions and automatically unlock virtual offsets as needed.

In some embodiments, the operator 150 provides input to the system 100 to change the status of one or more virtual offsets between the locked position and the unlocked position. In other embodiments, the processor 130 automatically determines the number and selection of restricted areas to unlock for a group of users 120. For example, the processor 130 may provide a default virtual reality environment size corresponding to a certain number of players 120, and may modify the virtual reality environment size through locking and unlocking virtual offsets as the number of players 120 change over the course of the game. The operator 150 may also change the status of virtual offsets during the game as well.

The virtual reality system 100 may include an alert system to direct players out of a restricted area before the restricted area is closed. The alert system may use visual (e.g., modified avatars, text, or lighting in the VR environment), audio (e.g., cautionary announcements or warning sounds), and/or physical cues (e.g., vibration in the HMD, an associated wearable, or other object associated with the user, such as a handheld tool). The alerts may be variable in intensity (e.g., increasing intensity as the closure of access to the restricted area is nearing) or may be simply binary (i.e., on/off).

It should be noted that various changes and modifications to the presently preferred embodiments described herein will be apparent to those skilled in the art. Such changes and modifications may be made without departing from the spirit and scope of the present invention and without diminishing its attendant advantages.

1. A system for dynamically modifying a scope of a virtual reality environment, the system comprising:
one or more user virtual reality devices associated with one or more users, respectively;
a processor in communication with the one or more user virtual reality devices; and
a memory in communication with the processor, the memory storing program instructions that, when executed by the processor, cause the processor to:
provide the virtual reality environment to the one or more users through the one or more user virtual reality devices, wherein the virtual reality environment includes a main area and at least one restricted area accessible through a virtual offset, wherein the virtual offset is set to a locked position or an unlocked position, wherein the one or more users explores the main area in the virtual reality environment;
when the virtual offset is unlocked, provide the one or more users access to the restricted area through the virtual offset; and
when the virtual offset is locked, restrict the one or more users from accessing the restricted area through the virtual offset.

2. The system of claim 1, wherein the virtual offset comprises a virtual graphic or activity;
wherein when the virtual offset is locked, the virtual graphic or activity is inoperable; and
wherein when the virtual offset is unlocked, the virtual graphic or activity is operable.

3. The system of claim 1, wherein the virtual offset comprises one of a manhole, a door, an elevator, a catapult, and a jetpack.

4. The system of claim 1, wherein the processor is further configured to receive input from an operator to change the virtual offset from the unlocked position to the locked position or from the locked position to the unlocked position.

5. The system of claim 1, wherein the processor is further configured to:
receive input from an operator related to the one or more users participating in the virtual reality environment;
determine an optimal surface area of the virtual reality environment based on the input;
compare the optimal surface area to a main area surface area of the main area and a restricted access surface area of at least one restricted area;
when the optimal surface area is greater than the main area surface area, set the virtual offset to the unlocked position and provide the user access to the at least one restricted area through the virtual offset;
when the optimal surface area is less than or equal to the main area surface area, set the virtual offset to the locked position and restrict the user from accessing the at least one restricted area through the virtual offset.

6. The system of claim 5, wherein the input includes the number of users and/or a level of experience of the number of users.

7. The system of claim 1, wherein the processor is further configured to:
monitor a pace of a game played by the one or more users participating in the virtual reality environment; and
if the pace of the game is above a threshold value, set the virtual offset from the locked position to the unlocked position and provide the one or more users access to the at least one restricted area.

8. The system of claim 7, wherein the pace of the game is monitored by completion of number of tasks within a time frame.

9. A method of dynamically modifying a scope of a virtual reality environment for a user, the method comprising the steps of:
providing the virtual reality environment to the user through a user virtual reality device, wherein the virtual reality environment includes a main area and at least one restricted area accessible through a virtual offset, wherein the virtual offset is set to a locked position or an unlocked position, wherein the user explores the main area in the virtual reality environment;
when the virtual offset is unlocked, providing the user access to the restricted area through the virtual offset; and
when the virtual offset is locked, restricting the user from accessing the restricted area through the virtual offset.

10. The method of claim 9, wherein the virtual offset comprises a virtual graphic or activity;
wherein when the virtual offset is locked, the virtual graphic or activity is inoperable; and
wherein when the virtual offset is unlocked, the virtual graphic or activity is operable.

11. The method of claim 9, further comprising the step of receiving input from an operator to change the virtual offset from the unlocked position to the locked position or from the locked position to the unlocked position.

12. The method of claim 9, further comprising the steps of:
receiving input from an operator related to a number of users participating in the virtual reality environment;
determining an optimal surface area of the virtual reality environment based on the input;
comparing the optimal surface area to a main area surface area of the main area and a restricted access surface area of at least one restricted area;
when the optimal surface area is greater than the main area surface area, setting the virtual offset to the unlocked position and provide the user access to the at least one restricted area through the virtual offset;
when the optimal surface area is less than or equal to the main area surface area, setting the virtual offset to the locked position and restrict the user from accessing the at least one restricted area through the virtual offset.

13. The method of claim 9, further comprising the steps of:
monitoring a pace of a game played by the one or more users participating in the virtual reality environment; and
if the pace of the game is above a threshold value, setting the virtual offset from the locked position to the unlocked position and providing the one or more users access to the at least one restricted area.
